(19) United States
(12) Patent Application Publication
(10) Pub. No.: US 2026/0042242 A1
(43) Pub. Date: Feb. 12, 2026

(54) SYSTEM AND METHOD FOR RECYCLING ASPHALT SHINGLES

(71) Applicant: IKO Industries Ltd., Toronto (CA)

(72) Inventor: Henry KOSCHITZKY, Toronto (CA)

(73) Assignee: IKO Industries Ltd., Toronto, ON (CA)

(21) Appl. No.: 19/290,938

(22) Filed: Aug. 5, 2025

Related U.S. Application Data
(60) Provisional application No. 63/682,328, filed on Aug. 12, 2024.

(51) Int. Cl. B29B 17/04; B29B 17/02; B29K 95/00; B29L 31/10; C08J 11/00

(52) U.S. Cl. CPC B29B 17/04; C08J 11/00; B29B 2017/0224; B29B 2017/0488; B29K 2095/00; B29L 2031/108; C08J 2395/00

(57) ABSTRACT

A system and method of producing a feedstock using asphalt shingle waste material includes: (a) providing an asphalt shingle material to a horizontal shaft hammer mill, and milling the material to produce a milled asphalt shingle material; (b) screening the milled asphalt shingle material to produce a milled and screened asphalt shingle material, wherein granules are removed from the milled asphalt shingle material; (c) introducing a heated asphalt flux to an attritor; (d) introducing the milled and screened asphalt shingle material to the attritor; (e) operating the attritor to process the contents of the attritor, producing a recycled asphalt mixture; and (f) passing the recycled asphalt mixture through a filter to produce an asphalt manufacturing feedstock.

### CROSS REFERENCE

This application claims the benefit of U.S. Provisional Ser. No. 63/682,328, filed on Aug. 12, 2024. The entire contents of the provisional application are hereby incorporated by reference.

### FIELD

The teaching disclosed herein relates generally to systems and methods for recycling asphalt shingle material, and specifically, to asphalt shingle material recycling systems and methods including the use of attritors.

### BACKGROUND

Canadian Patent No. 2,820,167 (Franzen) discloses a method for manufacturing a processed asphalt suspension composition. The method includes dry grinding shingle waste material with a vertical shaft impactor, removing granules from the ground shingle material to provide a ground recycled shingle material, introducing the ground recycled shingle material to a heated slurry tank containing virgin asphalt, transferring the mixture from the heated slurry tank to a wet griding machine, and recovering a processed asphalt suspension from the wet grinding machine. The wet grinding machine may comprise an attritor and the processed asphalt suspension comprises particles having a size no greater than 200 microns.

### SUMMARY

The following summary is intended to introduce the reader to various aspects of the applicant's teaching, but not to define any invention.

Disclosed herein is a method of producing a feedstock using asphalt shingle waste material, according to an embodiment. The method includes providing an asphalt shingle material to a horizontal shaft hammer mill, and milling the material to produce a milled asphalt shingle material, screening the milled asphalt shingle material to produce a milled and screened asphalt shingle material, wherein granules are removed from the milled asphalt shingle material, introducing a heated asphalt flux to an attritor, introducing the milled and screened asphalt shingle material to the attritor, operating the attritor to process the contents of the attritor, producing a recycled asphalt mixture, and passing the recycled asphalt mixture through a filter to produce an asphalt manufacturing feedstock.

According to some embodiments, the attritor is maintained at an elevated temperature while processing the contents of the attritor.

According to some embodiments, the attritor is maintained at a temperature between 175° C. and 260° C.

According to some embodiments, the asphalt manufacturing feedstock is a substantially liquid material.

According to some embodiments, the step wherein the recycled asphalt mixture is passed through a filter is configured to remove granule residue and/or impurities from the recycled asphalt mixture during filtering.

According to some embodiments, at least 99 percent by mass of solid particles present within the asphalt manufacturing feedstock have a maximum diameter less than 500 microns.

According to some embodiments, the asphalt shingle material is shredded before being provided to the hammer mill.

According to some embodiments, the asphalt shingle material is shredded into pieces having maximum dimensions of 32 cm in length and 9 cm in width.

According to some embodiments, the heated asphalt flux and the milled and screened asphalt shingle material are introduced to the attritor in proportions, by mass, of 35% to 95% heated asphalt flux and 5% to 65% milled and screened asphalt shingle material.

According to some embodiments, the asphalt flux is stored in a heated vessel before being provided to the attritor.

Disclosed herein is a system for recycling asphalt shingles to produce a feedstock, according to an embodiment. The system includes a horizontal shaft hammer mill configured to receive an asphalt shingle material as a mill input, and mill the asphalt shingle material, producing a milled asphalt shingle material as a mill output, a screener configured to receive the milled asphalt shingle material from the hammer mill as a screen input, and screen the milled asphalt shingle material to separate granules from the milled asphalt shingle material, producing a milled and screened asphalt shingle material as a screener output, an attritor configured to receive a heated asphalt flux as an attritor first input, and to receive the milled and screened asphalt shingle material from the screener as an attritor second input, and to process the attritor first input and the attritor second input in the attritor to produce a recycled asphalt mixture as an attritor output, and a filter configured to receive the recycled asphalt mixture from the attritor as a filter input, and filter the recycled asphalt mixture to produce an asphalt manufacturing feedstock as a filter output.

According to some embodiments, the attritor is configured to be maintained at an elevated temperature while processing the attritor first and second inputs.

According to some embodiments, the attritor is maintained at a temperature between 175° C. and 260° C.

According to some embodiments, the asphalt manufacturing feedstock is a substantially liquid material.

According to some embodiments, the filter is configured to remove granules and/or impurities from the recycled asphalt mixture during filtering.

According to some embodiments, at least 99 percent by mass of solid particles present within the asphalt manufacturing feedstock have a maximum diameter of less than 500 microns.

According to some embodiments, the system further includes a shredder configured to shred the asphalt shingle material and provide a shredded asphalt shingle material to the hammer mill as an input.

According to some embodiments, the shredded asphalt shingle material comprises pieces having maximum dimensions of 32 cm in length and 9 cm in width.

According to some embodiments, the attritor first input and attritor second input are delivered to the attritor in proportions, by mass, of 35% to 95% attritor first input and 5% to 65% attritor second input.

According to some embodiments, the asphalt flux is stored in a heated vessel before being provided to the attritor as an input.

Other aspects and features of the teachings disclosed herein will become apparent to those ordinarily skilled in the art, upon review of the following description of the specific examples of the present disclosure.

### DRAWINGS

For a better understanding of the described examples and to show more clearly how they may be carried into effect, reference will now be made, by way of example, to the accompanying drawings in which:

FIG. 1 is a schematic illustration of a system for recycling asphalt shingles; and

FIG. 2 is a flow chart depicting a method of recycling asphalt shingles.

The drawings included herewith are for illustrating various examples of apparatuses and methods of the teaching of the present specification and are not intended to limit the scope of what is taught in any way.

### DESCRIPTION

Various apparatuses or processes will be described below to provide an example of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an example of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

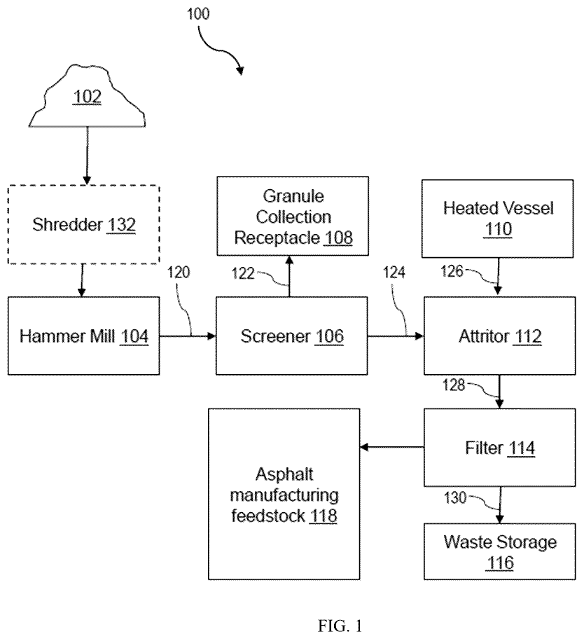

Referring to FIG. 1, a system 100 for recycling asphalt shingles includes a hammer mill 104, a screener 106, a heated vessel 110, an attritor 112, and a filter 114.

Reclaimed asphalt shingle material 102 is provided to the system 100 for processing. In the example illustrated, the reclaimed asphalt shingle material 102 comprises pieces of trimmings or other scrap from a shingle manufacturing process. In some examples, the reclaimed asphalt material 102 includes pieces of post-consumer shingle material, for example, end-of-life shingles removed from houses, and/or any other asphalt shingle material that is desirable to recycle. The constituent materials of the reclaimed asphalt shingle material 102 include, in the example illustrated, materials used to make finished shingles. This includes, for example, a substrate material and an asphalt coating material applied to the substrate. The substrate may comprise fiberglass, polyester, or any other suitable shingle substrate material. The reclaimed asphalt shingle material also contains, in the example illustrated, roofing granules embedded in the asphalt coating. The roofing granules include, for example, crushed stone and/or minerals, metal oxides, and colorants.

In the example illustrated, the hammer mill 104 comprises a housing for receiving the reclaimed asphalt shingle material 102 and, within the housing, a plurality of hammer elements attached to a rotary horizontal shaft. The shaft is rotated at high speed to cause the hammer elements to impact the material in the housing. This impact performs a pulverizing or grinding operation on the material in the housing, breaking apart the reclaimed asphalt shingle material 102 into smaller pieces, and breaking the granules free from the asphalt material. Further, some of the granules may be reduced in size through impact with the hammers of the hammer mill 104.

The reclaimed asphalt shingle material 102 is processed in the hammer mill 104 until a desired hammer mill output product (referred to herein as a ‘milled asphalt shingle material’ 120) is produced. In the example illustrated, the milled asphalt shingle material 120 is characterized at least in part by a particle size distribution wherein about 75% by mass of the milled asphalt shingle material 120 is sized having dimensions of about 75 mm by 125 mm. Furthermore, in the example illustrated, the remainder of the milled asphalt shingle material 120 comprises about 25% by mass of free granules. In the example illustrated, the free granules have a maximum size of about 1.7 mm. The free granules provide extracted granule material 122, as described in greater detail subsequently herein.

In some examples of the system 100, the reclaimed asphalt shingle material 102 may be pre-processed before being provided to the hammer mill 104. In the example illustrated, the reclaimed asphalt shingle material 102 is pre-processed in a shredder 132 upstream of the hammer mill 104. The shredder 132 may be any industrial shredder known in the art suitable for shredding asphalt shingles. In the example illustrated, the shredder 132 reduces the maximum size of the pieces of reclaimed asphalt shingle material 102 to pieces having maximum dimensions of about 15 by 25 centimeters. In other examples, the shredder 132 may reduce the maximum size of the pieces of reclaimed asphalt shingle material 102 to pieces having dimensions of at most 9 by 32 centimeters. Reducing the maximum size of the pieces of reclaimed asphalt shingle material 102 pieces that are fed to the hammer mill 104 can facilitate faster and/or more complete processing of the reclaimed asphalt shingle material 102 by the hammer mill 104, which can help to increase the overall efficiency of the system 100.

Referring still to FIG. 1, in the example illustrated, the milled asphalt shingle material 120 is transferred from the hammer mill 104 to the screener 106 by a transfer apparatus. In the example illustrated, the transfer apparatus comprises a conveyor belt. In some examples, the transfer apparatus can comprise a screw conveyor or another material handling system.

The screener 106 comprises an industrial screening machine, having at least one vibratory screen. The screen is provided with apertures sized to allow small particles to pass through the screen, thereby separating the small particles from the larger particles that cannot pass through the apertures. More particularly, in the example illustrated, the milled asphalt shingle material 120 is placed into the screener 106, and the screener 106 is activated to separate the free granules from the remaining larger components of the milled asphalt screening material 120. Accordingly, in the example illustrated, two separate outputs are provided, namely, extracted granule material 122 and milled and screened shingle material 124. The extracted granule material 122 may be transferred to a granule collection receptacle 108. The milled and screened asphalt shingle material 124 is, in the example illustrated, transferred to the attritor 112 for further processing. Transfer of the extracted granules 122 and the milled and screened asphalt shingle material 124 can be accomplished using a respective transfer apparatus comprising a conveyor belt, a screw conveyor, or another material handling system.

The extracted granule material 122 comprises particles having a maximum diameter of about 1.7 mm. More specifically, in the example illustrated, a sieve analysis of the extracted granule material 122 provides the following size distribution: Tyler Sieve 8 (2.38 mm): 0.0%, Tyler Sieve 10 (1.68 mm): 4.1%, Tyler Sieve 14 (1.19 mm): 26.3%, Tyler Sieve 20 (0.841 mm): 34.5%, Tyler Sieve 28 (0.595 mm): 22.5%, Tyler Sieve 35(0.420mm): 9.0%, pan: 3.4%.

The heated vessel 110 comprises a heated tank for storing molten asphalt (also called heated asphalt flux). The heated vessel 110 includes heating elements, for maintaining an elevated temperature of the contents of the heated vessel 110. In the example illustrated, the heated vessel 110 comprises a steel tank, fitted with external hot oil heating coils coupled to a hot oil flow controller or control system including a temperature sensor on the heated vessel 110, allowing for the contents of the heated vessel to be maintained at a desired elevated temperature. In other examples, the heated vessel may comprise any container known in the art suitable for storing and dispensing heated asphalt.

The heated vessel 110 is, in the example illustrated, provided with asphalt flux. The asphalt flux provided to the heated vessel 110 is maintained at an elevated temperature. In the example illustrated, the heated asphalt 126 within the heated vessel 110 is maintained at a temperature between 175° C. and 260° C. In some examples, the heated asphalt 126 within the heated vessel 110 may be maintained at a temperature of 200° C.

The heated asphalt 126 (also referred to herein as ‘attritor first input’) from heated vessel 110 and the milled and screened asphalt shingle material 124 (also referred to herein as ‘attritor second input’) are provided to the attritor 112. In the example illustrated, the heated asphalt 126 is provided first, followed by the milled and screened asphalt shingle material 124. In other examples, the milled and screened asphalt shingle material 124 may be provided first, followed by the heated asphalt 126. In other examples, the milled and screened asphalt shingle material 124 and the heated asphalt 126 may be provided to the attritor 112 at substantially the same time or in alternating increments (layering).

The milled and screened asphalt shingle material 124 and the heated asphalt material 124 are provided to the attritor 112 in specific proportions. In the example illustrated, the proportion, by mass, of heated asphalt flux is about 35% to 95%, and the proportion, by mass, of milled and screened asphalt shingle material is about 5% to 65%.

In the example illustrated, the heated asphalt 126 is transferred to the attritor 112 by a suitable conduit which can be pump fed and/or gravity fed. The milled and screened asphalt shingle material 124 is, in the example illustrated, transferred to the attritor 112 by a transfer apparatus comprising a conveyor. In other examples, alternative devices can be used for transfer of the heated asphalt 126 and the milled and screened shingle material 124 to the attritor 112.

In examples wherein material is transported by pump or conveyor, the pump or conveyor system may include components to measure the amount of material being dispensed by the pump or conveyor, such as an integrated flow meter or weigh scale. In such examples, the pumps and/or conveyors may be coupled to a controller 25 or controllers programmed to supply the input products to the attritor 112 at specific predetermined mass and/or volume ratios.

In the example illustrated, the attritor 112 is an industrial attritor, including a body or vessel, which is filled with pulverizing media, and further includes a stirring element. Pulverizing media in the example illustrated comprises steel spheres. The attritor 112 comprises a total gross volume of 600 gallons, but in other examples, the attritor 112 may be larger or smaller.

The stirring element of the attritor 112 is electrically driven and is coupled to a controller to allow for the rotational speed of the stirring element of the attritor 112 to be varied. In the example illustrated, the attritor 112 includes integrated heating elements, allowing for the temperature of the attritor 112 and its contents to be programmatically controlled.

The attritor 112 is operated under desired process parameters and length of time so that a desired output product is achieved, referred to as a ‘recycled asphalt mixture’ 128. In the example illustrated, the process parameters of the attritor 112 include use of half-inch (13mm) diameter spherical pulverizing media, a stirring element rotational speed of 65 to 68 RPM, and a temperature between 175° C. and 260° C., and a processing duration of 5 to 21 minutes. In other examples, other process parameters may be applied.

The recycled asphalt mixture 128 comprises a generally homogenous mixture of asphalt and particulate matter suspended in the asphalt. The particulate matter may include granule material and/or substrate material. In some examples, the maximum particle size within the recycled asphalt mixture 128 is 500 microns. In the example illustrated, at least 99 percent by mass of solid particles present within the asphalt manufacturing feedstock have a maximum diameter less than 500 microns. In the example illustrated, at least 1%, but not more than 5%, by mass of solid particles present within the asphalt manufacturing feedstock have a diameter between 300 microns and 500 microns.

In the example illustrated, the recycled asphalt mixture 128 is passed through the filter 114 after exiting the attritor 112. The filter 114 may comprise any filter suitable for filtering particles (e.g. granules) or impurities out of molten asphalt or bitumen mixtures. In the examples illustrated, the filter 114 is a Menestrina™ filter. The filter 114 is configured to separate the recycled asphalt mixture 128 into a filtrate 130 and an asphalt manufacturing feedstock 118. The filtrate 130 includes solid particles, remaining large granules and/or impurities extracted from the recycled asphalt mixture 128.

The asphalt manufacturing feedstock 118 is, in the example illustrated, conveyed or transported using piping and pumps. In other examples, the asphalt manufacturing feedstock 118 may be conveyed using different equipment, including, for example, a screw conveyor. The asphalt manufacturing feedstock 118 may be stored in any suitable vessel. In some examples, this storage vessel may include stirring elements and/or heating elements, to stir or agitate the feedstock 118 or maintain the feedstock 118 at an elevated temperature respectively.

The asphalt manufacturing feedstock 118 comprises a material that is suitable for use an in input in manufacturing asphalt-based materials, such as asphalt shingles, asphalt roofing membranes, paved road surfaces, asphalt coatings, fillers and any other asphalt materials. The asphalt manufacturing feedstock 118 may be provided as an input to a process that is configured to receive asphalt (e.g. asphalt flux, modified asphalt, oxidized asphalt, filled asphalt and/or other materials) as an input. In some examples, the asphalt manufacturing feedstock 118 may be provided to a process in combination with asphalt, at a particular ratio. For example, a mixture of asphalt and the asphalt manufacturing feedstock 118 may be provided, in which the mixture comprises 2 percent asphalt manufacturing feedstock 118 by mass. In other examples, a mixture of asphalt and the asphalt manufacturing feedstock 118 may be provided, the mixture comprising 10 percent asphalt manufacturing feedstock 118 by mass.

In the example illustrated, the asphalt manufacturing feedstock 118 comprises the following particle size distribution according to sieve analysis when the attritor 112 is operated for 5 minutes: Tyler Sieve 48 (0.297 mm): 1.3%, Tyler Sieve 65 (0.210 mm): 1.2%, Tyler Sieve 100 (0.149 mm): 2.1%, Tyler Sieve 200 (0.074 mm): 11.7%, pan: 83.6%.

In the example illustrated, the asphalt manufacturing feedstock 118 comprises the following particle size distribution according to sieve analysis when the attritor 112 is operated for 10 minutes: Tyler Sieve 48 (0.297 mm): 0.8%, Tyler Sieve 65 (0.210 mm): 0.9%, Tyler Sieve 100 (0.149 mm): 1.4%, Tyler Sieve 200 (0.074 mm): 8.9%, pan: 87.9%.

While the system 100 is described herein discussed as a system configured to operate as a batch configuration process, in other embodiments, the system may be configured to operate as a continuous process.

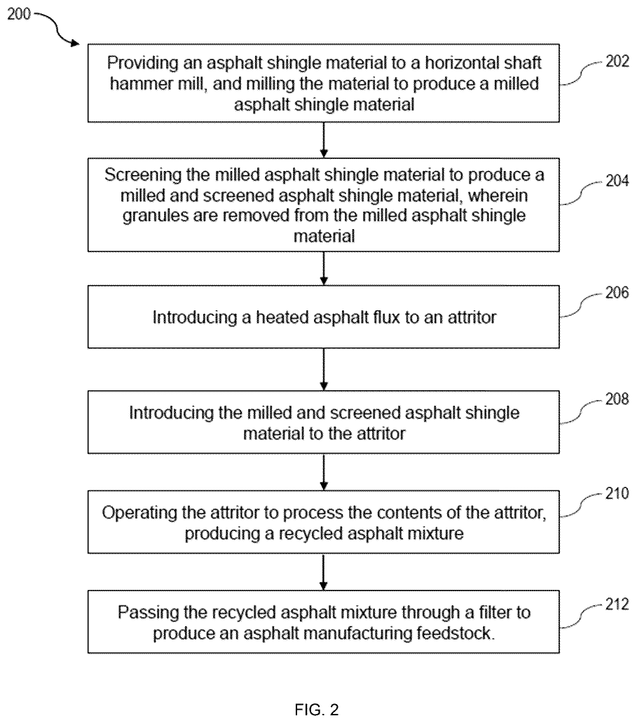

Referring to FIG. 2, shown therein is a flowchart depicting a method 200 of recycling asphalt shingles. Method 200 includes operations 202, 204, 206, 208, 210 and 212. While operations of method 200 are presented in sequential order in the example illustrated, in other examples, method 200 may be conducted in different orders.

Method 200 may correspond to a method of operation of system 100 which is described above. Description above in reference to system 100 similarly applies to method 200 described herein.

At operation 202, an asphalt shingle material is provided to a horizontal shaft hammer mill, and the material is milled to produce a milled asphalt shingle material.

At operation 204, the milled asphalt shingle material is screened to produce a milled and screened asphalt shingle material. During 204, granules are removed from the milled asphalt shingle material.

At operation 206, a heated asphalt flux is introduced to an attritor.

At operation 208, milled and screened asphalt shingle material is introduced to the attritor.

At operation 210, the attritor is operated to process the contents of the attritor, producing a recycled asphalt mixture.

At operation 212, the recycled asphalt mixture is passed through a filter to produce an asphalt manufacturing feedstock.

What has been described above is intended to be illustrative of examples of the teaching disclosed herein, without limiting the scope of patent claims granted herefrom. The scope of such claims should be given the broadest interpretation consistent with the description as a whole.

What is claimed is:

1. A system for recycling asphalt shingles to produce an asphalt manufacturing feedstock, the system comprising:
a horizontal shaft hammer mill configured to receive asphalt shingle material and to mill the asphalt shingle material to produce a milled asphalt shingle material;
a screener configured to receive the milled asphalt shingle material and to remove granules therefrom, producing a milled and screened asphalt shingle material;
an attritor configured to receive:
a heated asphalt flux as a first input; and
the milled and screened asphalt shingle material as a second input,
wherein the attritor is further configured to operate at an elevated temperature between 175° C. and 260° C. and to process the first and second inputs to produce a recycled asphalt mixture; and
a filter configured to receive the recycled asphalt mixture from the attritor and to filter the recycled asphalt mixture to produce the asphalt manufacturing feedstock, wherein the asphalt manufacturing feedstock comprises at least 99 percent by mass of solid particles having a maximum diameter of less than 500 microns.

2. The system of claim 1, further comprising a shredder configured to shred the asphalt shingle material into pieces having maximum dimensions of about 32 cm in length and 9 cm in width before the material is provided to the hammer mill.

3. The system of claim 1, wherein the attritor comprises an integrated heating system configured to maintain the internal temperature of the attritor between 175° C. and 260° C. during operation.

4. The system of claim 1, wherein the filter is configured to remove granule residue and impurities from the recycled asphalt mixture.

5. The system of claim 1, wherein the asphalt manufacturing feedstock is a substantially liquid material.

6. The system of claim 1, wherein the proportions by mass of the first input and the second input provided to the attritor are from 35% to 95% heated asphalt flux and 5% to 65% milled and screened asphalt shingle material.

7. The system of claim 1, wherein the hammer mill comprises a plurality of hammer elements attached to a rotary horizontal shaft.

8. The system of claim 1, wherein the screener comprises a vibratory screen having apertures sized to separate particles having a maximum diameter of 1.7 mm from the milled asphalt shingle material.

9. The system of claim 1, wherein the attritor includes pulverizing media and a stirring element operated at a variable speed controlled by a controller.

10. The system of claim 1, wherein at least 1% and not more than 5% by mass of solid particles in the asphalt manufacturing feedstock have diameters between 300 microns and 500 microns.

11. A method of producing an asphalt manufacturing feedstock from asphalt shingle waste material, the method comprising:
providing asphalt shingle material to a horizontal shaft hammer mill and milling the material to produce a milled asphalt shingle material;
screening the milled asphalt shingle material to remove granules and produce a milled and screened asphalt shingle material;
introducing a heated asphalt flux maintained at a temperature between 175° C. and 260° C. to an attritor;
introducing the milled and screened asphalt shingle material to the attritor;
operating the attritor to process the heated asphalt flux and the milled and screened asphalt shingle material, producing a recycled asphalt mixture; and
passing the recycled asphalt mixture through a filter to remove granule residue or impurities and produce the asphalt manufacturing feedstock, wherein at least 99 percent by mass of solid particles in the asphalt manufacturing feedstock have a maximum diameter of less than 500 microns.

12. The method of claim 11, further comprising shredding the asphalt shingle material into pieces having maximum dimensions of about 32 cm in length and 9 cm in width prior to providing it to the hammer mill.

13. The method of claim 11, wherein the milled and screened asphalt shingle material is introduced into the attritor in a mass ratio to the heated asphalt flux ranging from 5% to 65%.

14. The method of claim 11, wherein the heated asphalt flux is stored in a heated vessel prior to being introduced into the attritor.

15. The method of claim 11, wherein operating the attritor includes maintaining a temperature between 175° C. and 260° C. and stirring a pulverizing media within the attritor.

16. The method of claim 11, wherein operating the attritor comprises stirring the contents for a duration of 5 to 21 minutes at a stirring element speed of 65 to 68 RPM.

17. The method of claim 11, wherein the step of passing the recycled asphalt mixture through a filter removes granules and impurities having a particle size greater than 500 microns.

18. The method of claim 11, wherein the asphalt manufacturing feedstock is used as an input for manufacturing asphalt shingles, roofing membranes, or road surfacing materials.

19. The method of claim 11, wherein the milled asphalt shingle material is transferred to the screener using a conveyor belt or screw conveyor.

20. The method of claim 11, wherein the asphalt manufacturing feedstock includes a homogeneous mixture of asphalt and particulate matter suspended within the asphalt.
